(19) United States
(12) Patent Application Publication
(10) Pub. No.: US 2018/0070370 A1
(43) Pub. Date: Mar. 8, 2018

(54) COMMUNICATION DEVICE, COMMUNICATION SYSTEM, AND COMMUNICATION METHOD

(71) Applicant: Mototsugu Emori, Tokyo (JP)

(72) Inventor: Mototsugu Emori, Tokyo (JP)

(73) Assignee: Ricoh Company, Ltd., Tokyo (JP)

(21) Appl. No.: 15/695,609

(22) Filed: Sep. 5, 2017

(30) Foreign Application Priority Data
Sep. 6, 2016 (JP) 2016-173606
Apr. 25, 2017 (JP) 2017-086114

(51) Int. Cl. H04W 72/12; H04W 28/24; H04W 80/10

(52) U.S. Cl. CPC H04W 72/1231; H04W 28/24; H04L 65/80; H04W 80/10; H04W 72/1242

(57) ABSTRACT

A communication device includes circuitry to perform wireless communication with other communication device using at least one wireless communication method, determine a provision level of a service to be provided to the other communication device, based on characteristic information on the wireless communication being performed, and provide, to the other communication device, a service limited with a degree of the service that has been determined in accordance with the determined provision level.

### CROSS-REFERENCE TO RELATED APPLICATIONS

This patent application is based on and claims priority pursuant to 35 U.S.C. §119(a) to Japanese Patent Application Nos. 2016-173606, filed on Sep. 6, 2016, and 2017-086114, filed on Apr. 25, 2017, in the Japan Patent Office, the entire disclosure of which is hereby incorporated by reference herein.

### BACKGROUND

### Technical Field

The present invention relates to a communication device, a communication system, and a communication method.

### Description of the Related Art

With the spread use of wireless local area networks (LANs) and mobile terminals, such as smartphones and tablets, services have appeared that are capable of performing screen projection and printing, by directly connecting a mobile terminal to a device through radio, such as Miracast (registered trademark) and AirPrint. Wi-Fi Alliance (registered trademark) has met specifications for services to be provided after peer-to-peer (P2P) connection is made between devices through radio, and an infrastructure (application services platform (ASP)) that unifies the services (Wi-Fi Direct (registered trademark) services Version1.1@2014-08-21). Since the services have been standardized in the Wi-Fi Direct services (hereinafter, referred to as WFDS), devices according to the services become maker-independent so that multi-vendor support is achieved. Since the services operate on a common platform, a common connection procedure is provided so that detection, connection, and execution are easily made.

In WFDS standards, Wi-Fi Direct has been functionally extended and has a service searching function added. Specifically, the services can be searched through radio at a stage before connection, differently from a conventional service searching function using universal plug and play (UPnP).

### SUMMARY

Embodiments of the present invention include a communication device including: circuitry to perform wireless communication with other communication device using at least one wireless communication method, determine a provision level of a service to be provided to the other communication device, based on characteristic information on the wireless communication being performed, and provide, to the other communication device, a service limited with a degree of the service that has been determined in accordance with the determined provision level.

Embodiments of the present invention include a system including the above-described communication device, a communication method performed by the above-described communication device, and a communication control program stored in a recording medium to cause the communication device to perform the communication method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram of a hardware configuration of a communication device used in a communication system according to an embodiment;

FIG. 2 is a functional block diagram of an exemplary configuration of the communication system including a first communication device and a second communication device;

FIGS. 3A and 3B (FIG. 3) are a sequence diagram of an exemplary entire operation of the communication system according to the embodiment;

FIG. 4 is a flowchart of processing (an exemplary first operation) performed in a case where a provision level determining unit determines the provision level of a service;

FIG. 5 is a table exemplifying service information on a Print service;

FIGS. 6A and 6B (FIG. 6) are table illustrating a settable value and a default value for each Key in the Print service;

FIG. 7 is a table exemplifying service provision permission information on the Print service;

FIG. 8 is a table exemplifying service information on a Send service;

FIG. 9 is a table exemplifying service provision permission information on the Send service;

FIG. 10 is a table exemplifying service provision permission information on a Play service;

FIG. 11 is a table exemplifying service provision permission information on a Display service;

FIG. 12 is a flowchart of processing performed in a case where an ASP generates service information;

FIG. 13 is a flowchart of processing performed in a case where a session connection determining unit determines session connection;

FIG. 14 is a flowchart of processing (an exemplary second operation) performed in a case where the provision level determining unit determines the provision level of the service; and

FIG. 15 is a flowchart of processing (an exemplary third operation) performed in a case where the provision level determining unit determines the provision level of the service.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

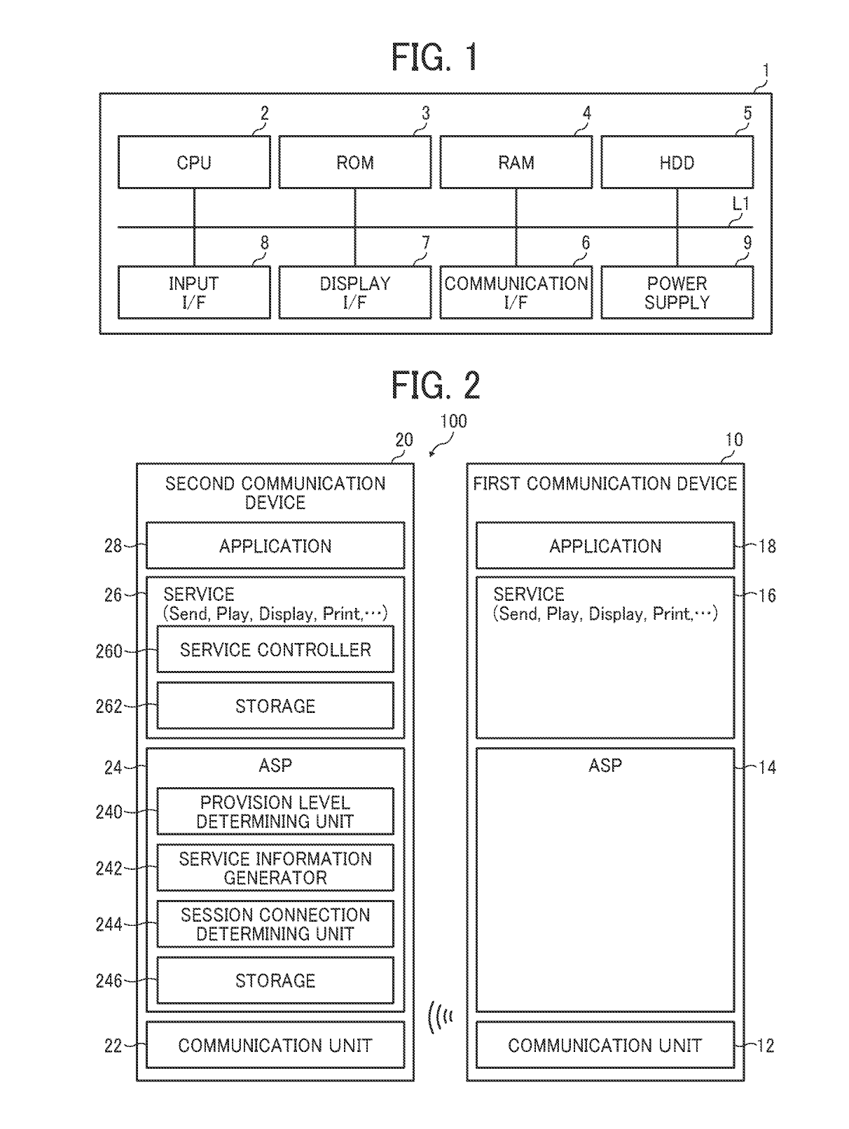

A communication system according to an embodiment will be described in detail below with reference to the attached drawings. FIG. 1 is a diagram of a hardware configuration of a communication device used in a communication system according to the embodiment.

As illustrated in FIG. 1, the communication device 1 includes a central processing unit (CPU) 2, a read only memory (ROM) 3, a random access memory (RAM) 4, a hard disk drive (HDD) 5 or a solid-state drive (SSD), a communication interface (I/F) 6, a display I/F 7, an input I/F 8, and a bus L1 coupling these units to each other. Driving power for each unit is supplied from a power supply 9.

The CPU 2 controls the operation of the communication device 1. The ROM 3 stores a basic input/output program. The RAM 4 is used as a work area for the CPU 2.

The HDD 5 is an exemplary non-volatile storage device that stores an operating system (OS) and various applications. Note that, a drive device using a flash memory as a storage medium (e.g., a solid-state drive (SSD)) may be used instead of the HDD 5.

The communication I/F 6 performs communication with the nearest base station device, wireless LAN communication with an access point, or near field communication. The communication I/F 6 may be implemented by, for example, a network interface circuit.

The display I/F 7 includes a connection interface for a display that displays various types of information. The input I/F 8 includes a connection interface for an external input device, such as a keyboard or a mouse. Note that, the input I/F 8 may include a touch panel or an operation button.

The bus L1 electrically connects these units to each other.

FIG. 2 is a functional block diagram of an exemplary configuration of a communication system 100 including a first communication device 10 and a second communication device 20 each having the hardware configuration described above. The CPU 2 loads a predetermined program from the HDD 5 into the RAM 4 and then executes the program so as to achieve each function illustrated in FIG. 2. In the communication system 100, the first communication device 10 is an end that receives service provision (a request sending end) and the second communication device 20 is an end that provides the service (a request receiving end).

The second communication device 20 includes a communication unit 22, an application service platform (ASP) 24, a service 26, and an application 28. At least one wireless communication method allows the communication unit 22 to perform wireless communication with a different communication device. For example, the communication unit 22 can perform wireless communication conforming to an IEEE 802.11 standard, certified by Wi-Fi Alliance (hereinafter, appropriately referred to as Wi-Fi (registered trademark)), and wireless communication with Bluetooth (registered trademark) Low Energy.

Furthermore, the communication unit 22 can perform wireless communication with near field communication (NFC). The communication unit 22 may include a wireless communication function of achieving neighbor awareness networking (NAN). Here, the description will be given with an exemplary case where the communication unit 22 is allowed to perform at least the wireless communication with Wi-Fi and the wireless communication with NFC. In this embodiment, the communication unit 22 may be implemented by the communication I/F 6 that cooperates with the CPU 2, or the instructions of the CPU 2.

The ASP 24 includes a provision level determining unit 240, a service information generator 242, a session connection determining unit 244, and a storage 246, having an ASP function in Wi-Fi Direct, so as to perform service searching, session establishment, P2P group formation, and port opening for service communication.

Based on characteristic information on the wireless communication performed by the communication unit 22 with the different communication device, such as the first communication device 10, the provision level determining unit 240 determines the provision level of the service to be provided to the first communication device 10 (a service provision level). More specifically, the provision level determining unit 240 determines the provision level, with, as the characteristic information, at least one of the received signal strength indicator (RSSI) of the wireless communication performed by the communication unit 22, a beacon count received by the communication unit 22 for a predetermined period of time, and the type of the wireless communication method with which the communication unit 22 has started the wireless communication with the different communication device.

The service information generator 242 generates service information including open information on the service available to the different communication device, such as the first communication device 10, in response to the provision level determined by the provision level determining unit 240.

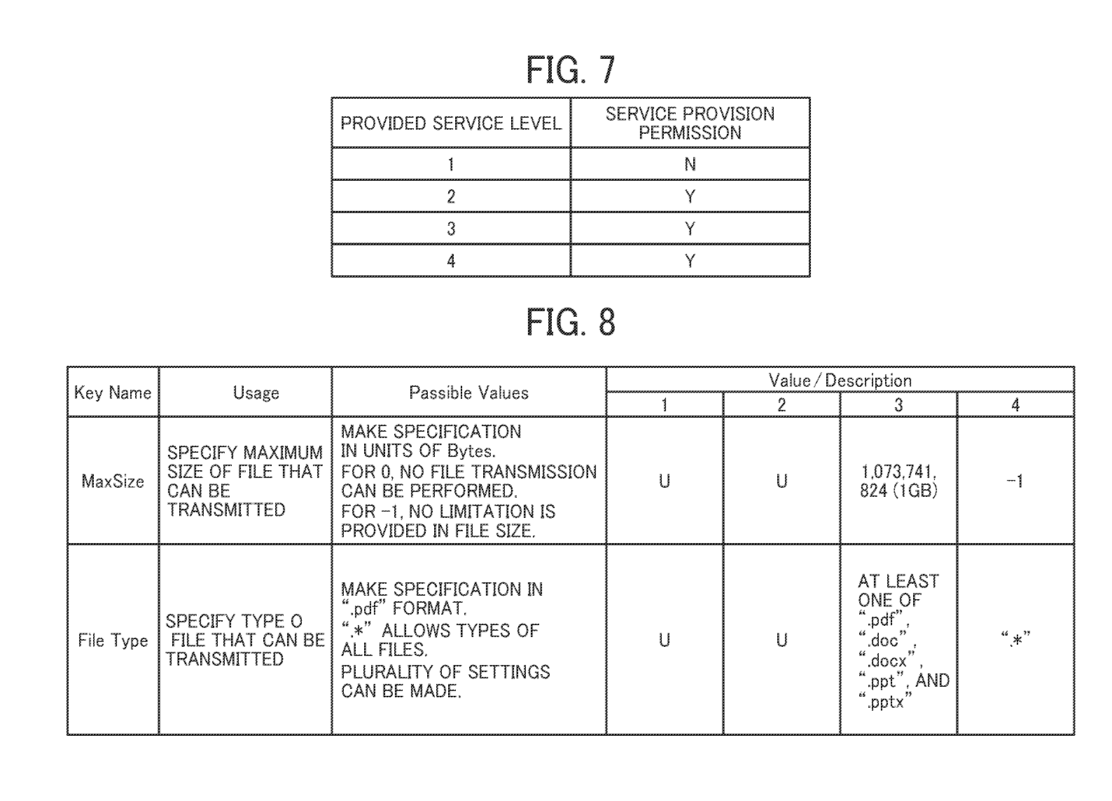

In a case where a session connection request for starting provision of the service has been received, the session connection determining unit 244 determines whether to permit the session connection request, based on the provision level determined by the provision level determining unit 240 and service provision permission information (to be described later with FIG. 7). The session connection determining unit 244 establishes a session for starting the provision of the service in a case where permitting the session connection request. The storage 246 uses a memory (e.g., the RAM 4) so as to store the service information and the service provision permission information.

The service 26 performs communication unique to the service, with a port opened by the ASP 24. Services, such as Send, Play, Print, and Display, are prescribed in WFDS standards. The service 26 further includes a service controller 260 and a storage 262. The service controller 260 performs processing of registering (storing) the service information and the service provision permission information into the ASP 24. The storage 262 uses a memory (e.g., the RAM 4) so as to store the service information and the service provision permission information.

Note that, the ASP 24 and the service 26 are implemented by a processor such as a CPU 2, which operates as the second communication device 20, the ASP 24 including the provision level determining unit 240, the service information generator 242, the session connection determining unit 244, according to a control program stored in the storage 262. The service 26 including the service controller 260 is implemented by the CPU 2, which operates according to a control program stored in the storage 246, for example.

The application 28 uses the service 26.

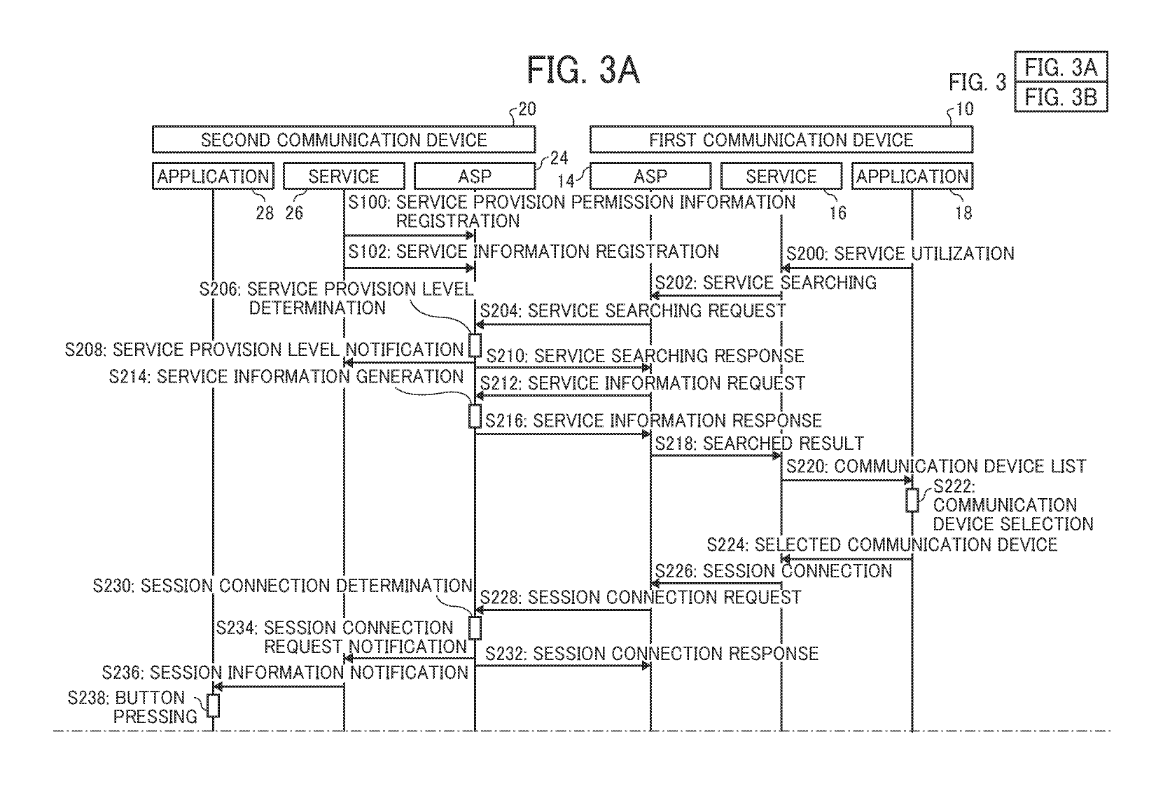

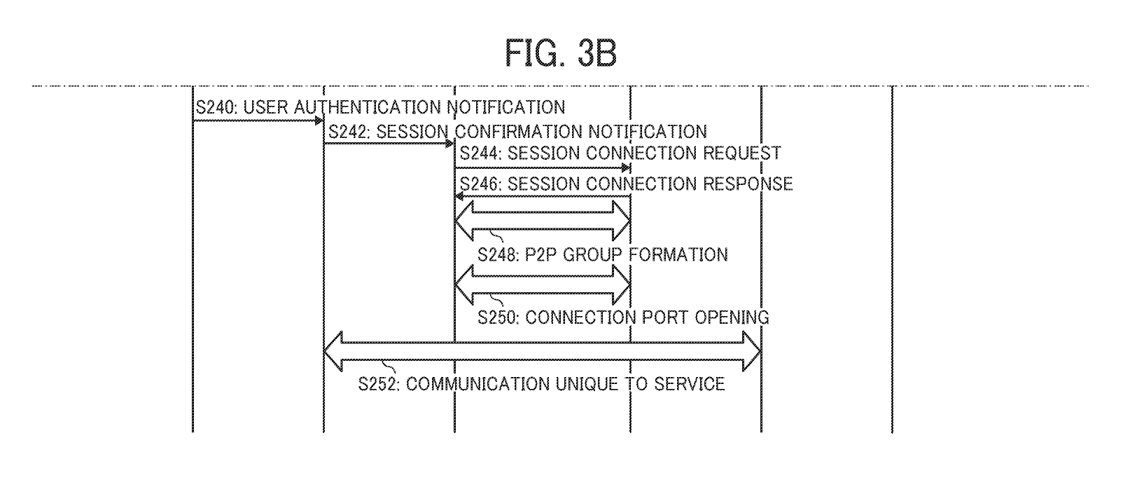

The first communication device 10 includes a communication unit 12, an application service platform (ASP) 14, a service 16, and an application 18, and has a configuration substantially the same as the configuration of the second communication device 20. Each unit included in the first communication device 10, has a function similar to the function of each unit included in the second communication device 20. However, since the first communication device 10 has been defined as the end that receives the service provision (the request sending end), each unit included in the first communication device 10 is not necessarily the same as each unit included in the second communication device 20. The operation of the first communication device 10 will be described later with FIG. 3.

Next, an exemplary operation of the communication system 100 will be described. FIG. 3 is a sequence diagram of an exemplary entire operation of the communication system 100. As illustrated in FIG. 3, the service 26 of the second communication device 20 first registers the service provision permission information into the ASP 24 (S100) and additionally registers the service information (S102).

After the service provision permission information and the service information are registered into the ASP 24, when the application 18 of the first communication device 10 sends a request to the service 16 for service utilization in response to the operation of a user (S200), the service 16 sends a request to the ASP 14 for service searching (S202). When the service searching is requested, the ASP 14 transmits a service searching request to the second communication device 20 through the communication unit 12 (S204).

When the ASP 24 of the second communication device 20 receives the service searching request through the communication unit 22, the provision level determining unit 240 determines the provision level of the service to be provided to the first communication device 10, based on the characteristic information on the wireless communication, such as the RSSI (S206), and then notifies the service 26 of the service provision level that has been determined (S208). The ASP 24 responds to the service searching request from the first communication device 10, through the communication unit 22 (S210).

The first communication device 10 that has received the service searching response, further transmits a service information request to the second communication device 20 (S212). When the second communication device 20 receives the service information request from the first communication device 10, the service information generator 242 generates the service information to be open to the first communication device 10, based on the service provision level determined by the provision level determining unit 240 (S214). The ASP 24 transmits, as a response, the service information generated by the service information generator 242 to the first communication device 10 (S216).

When the first communication device 10 receives the service information, the ASP 14 notifies the service 16 of a searched result (S218), and the service 16 outputs a list of communication devices with which the response has been made, to the application 18 (S220).

When displaying the list of communication devices that has been input and receiving an input from the user who selects any of the communication devices with which the service is used (here, the second communication device 20) (S222), the application 18 notifies the service 16 of the communication device selected by the user (S224). The service 16 makes a request to the ASP 14 for session connection (S226), and the ASP 14 transmits the session connection request to the second communication device 20 through the communication unit 12 so as to attempt the connection with the second communication device 20 (S228).

When the second communication device 20 receives the session connection request from the first communication device 10, the session connection determining unit 244 of the ASP 24 determines the session connection, based on the service provision permission information (S230). In a case where rejecting the session connection request, the ASP 24 makes a reject response to the first communication device 10 so as to complete the communication (S232). In a case where permitting the session connection request, the ASP 24 notifies the service 26 of the session connection request (S234) and additionally temporarily responds to the session connection request from the first communication device (S232). When being notified of the session connection request, the service 26 notifies the application 28 of session information (S236).

The application 28 performs authentication in response to button depression by the user (S238), and outputs a user authentication notification to the service 26 (S240). When receiving the user authentication notification, the service 26 outputs a session confirmation notification to the ASP 24 (S242). When receiving the session confirmation notification, the ASP 24 next transmits a session connection request from the second communication device to the first communication device 10 through the communication unit 22 (a P2Ps default configuration method: S244).

Note that, instead of the button depression by the user on the application 28, the second communication device 20 may display a personal information number (PIN) code and the user may input the PIN code displayed on the side of the first communication device 10.

When receiving the session connection request from the second communication device 20, the ASP 14 of the first communication device 10 responds to the second communication device 20 (S246). Then, the first communication device 10 and the second communication device 20 perform connection processing in Wi-Fi Direct (P2P group formation) (S248) and perform open processing of the port used in the service (S250) so as to start the communication unique to the service (S252). (Refer to Wi-Fi Peer-to-Peer Services Technical Specification Version1.1, p. 42, FIGS. 8 and 11.)

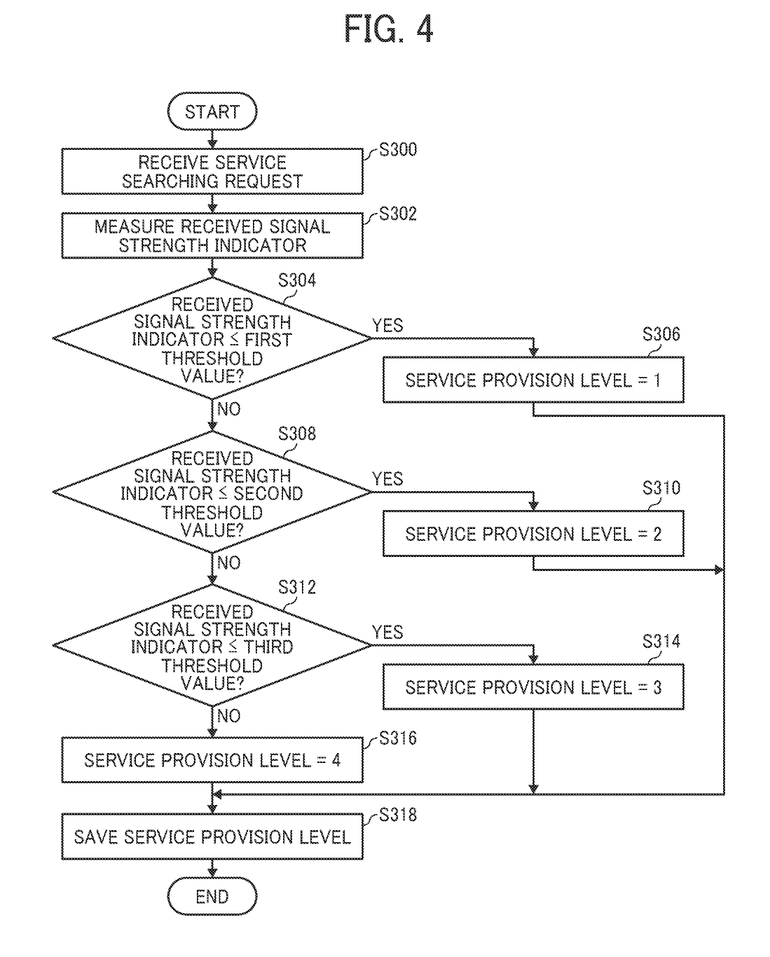

Next, the processing performed by the second communication device 20, will be further described. FIG. 4 is a flowchart of processing (an exemplary first operation) performed in a case where the provision level determining unit 240 determines the provision level of the service. As illustrated in FIG. 4, the provision level determining unit 240 receives the service searching request from the first communication device 10 through the communication unit 22 (S300) so as to start determination processing of the provision level of the service.

Here, the provision level of the service is a determiner for the level (the degree) of the service in quality, provided by the second communication device 20. The service high in quality (with a high level) is received as the level is high. For example, the level in the Print service includes level 1 at which printing is disabled, levels 2 and 3 at which the printing in black and white can be performed, and level 4 at which the printing in color can be performed, set. Here, the service provision level includes levels 1 to 4 set.

When receiving the service searching request, for example, the provision level determining unit 240 measures, as the characteristic information, the received signal strength indicator (RSSI) of the service searching request (S302). As the RSSI is smaller in value (absolute value), the intensity of an electric field is high so that the first communication device 10 and the second communication device 20 are indicated to be close to each other in distance. dBm (Decibel-milliwatt) is used as a unit.

The provision level determining unit 240 determines whether the value of the RSSI is equal to or less than a threshold value, and based on determination, determines a provision level of the service (S304 to S316). In this example, three threshold values including first to third threshold values are used, to select the provision level of the service from levels 1 to 4.

For example, when the value of the RSSI is −87 dBm (the first threshold value) or less, the provision level determining unit 240 sets level 1. When the value of the RSSI is −75 dBm (the second threshold value) or less, the provision level determining unit 240 sets level 2. When the value of the RSSI is −63 dBm (the third threshold value) or less, the provision level determining unit 240 sets level 3. When the value of the RSSI is more than the third threshold value, the provision level determining unit 240 sets level 4. Then, the provision level determining unit 240 saves the service provision level that has been determined, into the storage 246 in association with the ID of the first communication device 10 (S318).

Note that, instead of the RSSI, the provision level determining unit 240 may determine the provision level of the service with the distance (d, unit: m) between the second communication device 20 and the first communication device 10 calculated from the absolute value of the RSSI and a transmission power (TxPower) value (unit: dBm). In this case, the distance d between the second communication device 20 and the first communication device 10, is calculated by Expression 1 below.

d=10̂((TxPower-RSSI)/20) (1)

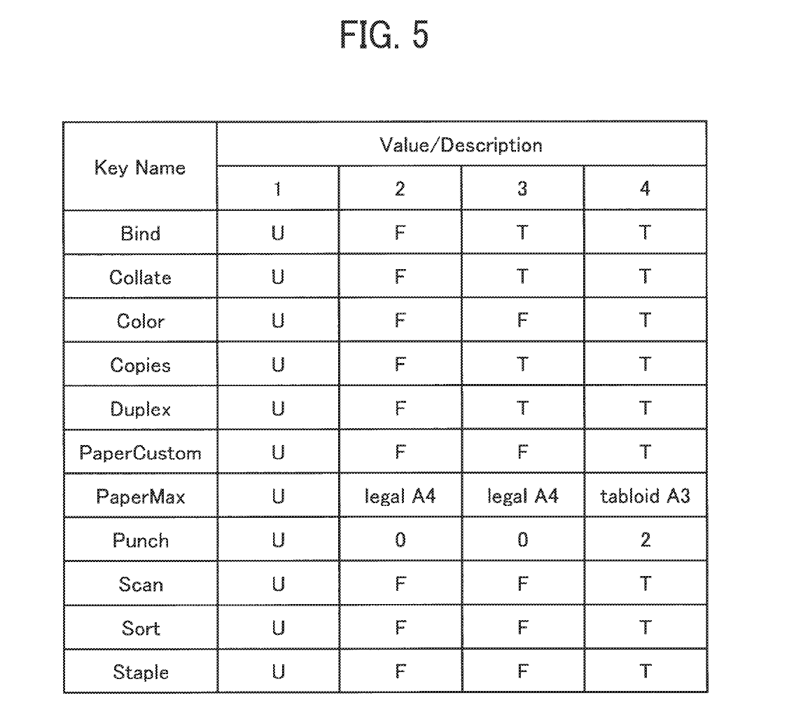

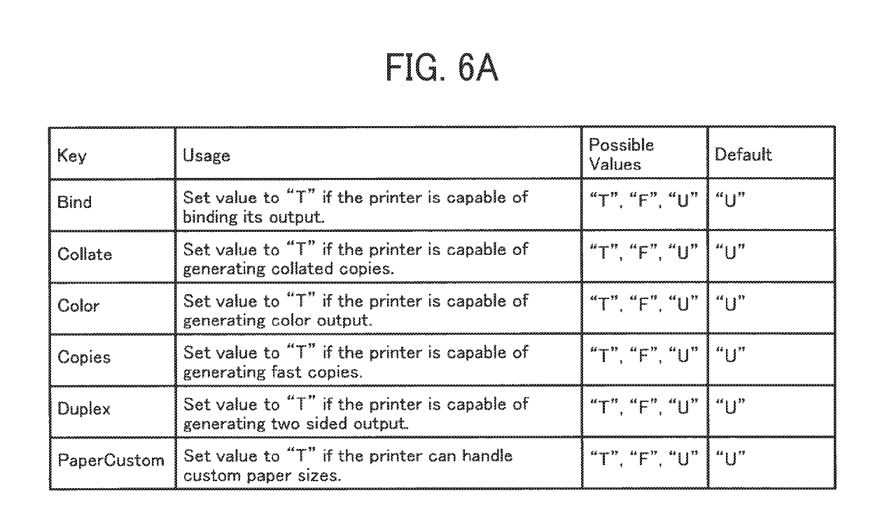

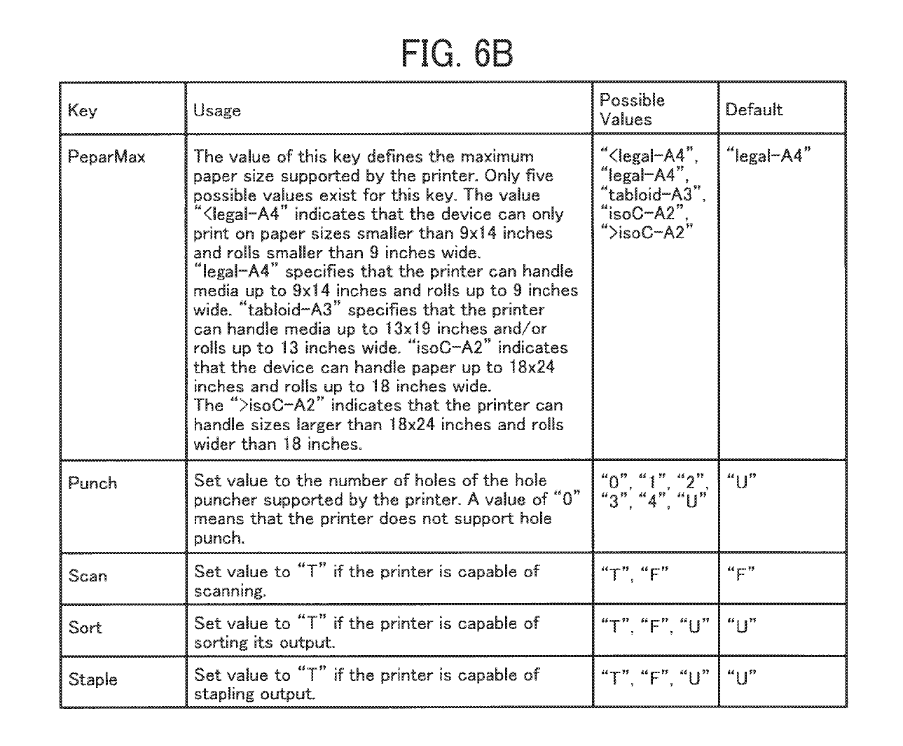

As described above, the services, such as the Send, the Play, the Print, and the Display, are prescribed in the WFDS standards. First, a specific example of the service information will be described with the Print service. FIG. 5 is a table exemplifying the service information on the Print service. FIG. 6 is a table illustrating a settable value and a default value for each Key in the Print service. (Refer to Wi-Fi Peer-to-Peer Services Technical Specification Version1.1 7.3.1.1.)

The service 26 of the second communication device 20 (here, the Print) has print settings, such as Bind and Collate. U, F, or T is set per service provision level for each print setting. For the U (Unknown), the setting is made not to be open in addition to being unusable. For the F (False), the setting is made to be open, but is unusable. For the T (True), the setting is made to be open, and is usable.

The service information has been saved in the storage 262 of the service 26. Before the start of the entire processing (e.g., when the second communication device 20 boots up), the service 26 obtains the service information from the storage 262 so as to notify the ASP 24 of the service information. The ASP 24 saves the service information with which the notification has been made, into the storage 246 in association with a service ID.

FIG. 7 is a table exemplifying service provision permission information on the Print service. The service provision permission information indicates from which level the service is permitted to be provided. In FIG. 7, in a case where a value corresponding to the service provision level is N, the service is not provided at the level. In a case where the value corresponding to the service provision level is Y, the service provision is permitted at the level.

In a case where the first communication device 10 has transmitted the session connection request in order to start performing the service, the service provision permission information is used for the determination of whether the second communication device 20 rejects the request. The service provision permission information is saved into the storage 246 in association with the service ID. In the example illustrated in FIG. 7, the service is not provided in a case where the service provision level indicates 1 and the service is provided in a case where the service provision level indicates 2, 3, or 4.

FIG. 8 is a table exemplifying service information on the Send service. The Send service transmits a file. The Send service has two settings including MaxSize that specifies a maximum size of the file that can be transmitted and FileType that specifies a type of the file that can be transmitted. Here, at levels 1 and 2, the settings are made not to be open, and are unusable. At level 3, the file having 1 GB in size can be transmitted and the file having a specific file format can be transferred. At level 4, no limitation is provided in file size and file format.

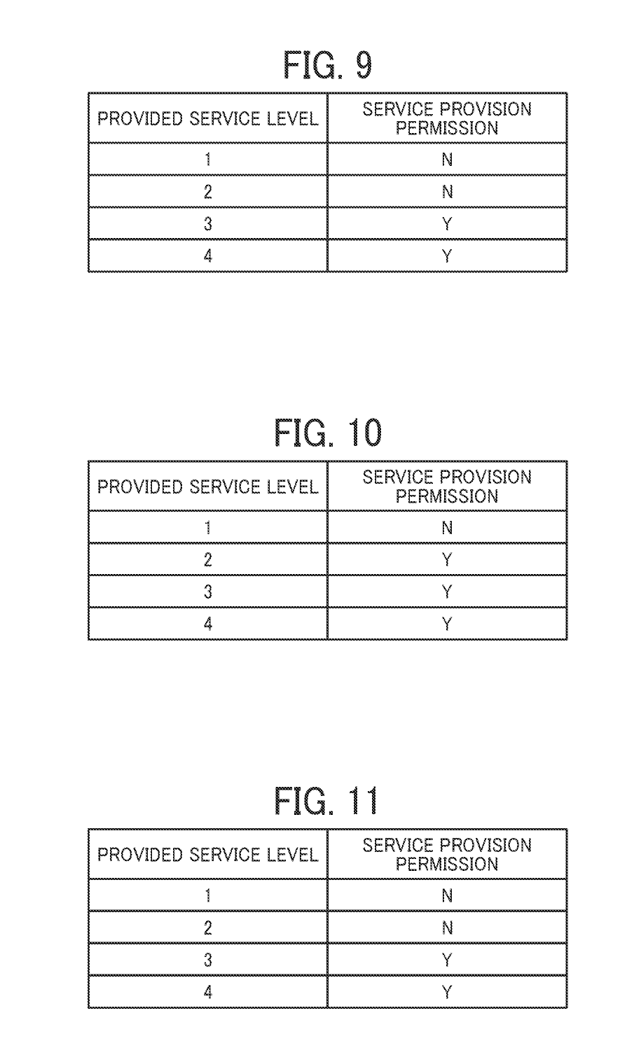

FIG. 9 is a table exemplifying service provision permission information on the Send service. In the example illustrated in FIG. 9, the service provision is rejected in a case where the service provision level indicates 1 or 2 and the service provision is permitted in a case where the service provision level indicates 3 or more. Here, the service provision is permitted in a case where a high service level is provided. This is because a sufficient band is required for a file transfer.

FIG. 10 is a table exemplifying service provision permission information on the Play service. The Play service obeys a digital living network alliance (DLNA (registered trademark)) guide line. In the example illustrated in FIG. 10, the service provision is rejected in a case where the service provision level indicates 1 and the service provision is permitted in a case where the service provision level indicates 2 or more.

FIG. 11 is a table exemplifying service provision permission information on the Display service. The Display service includes a Miracast service. In the example illustrated in FIG. 11, the service provision is rejected in a case where the service provision level indicates 1 or 2 and the service provision is permitted in a case where the service provision level indicates 3 or more. Here, the service provision is permitted in a case where a high service level is provided. This is because Miracast is a screen transfer service and a sufficient band is required.

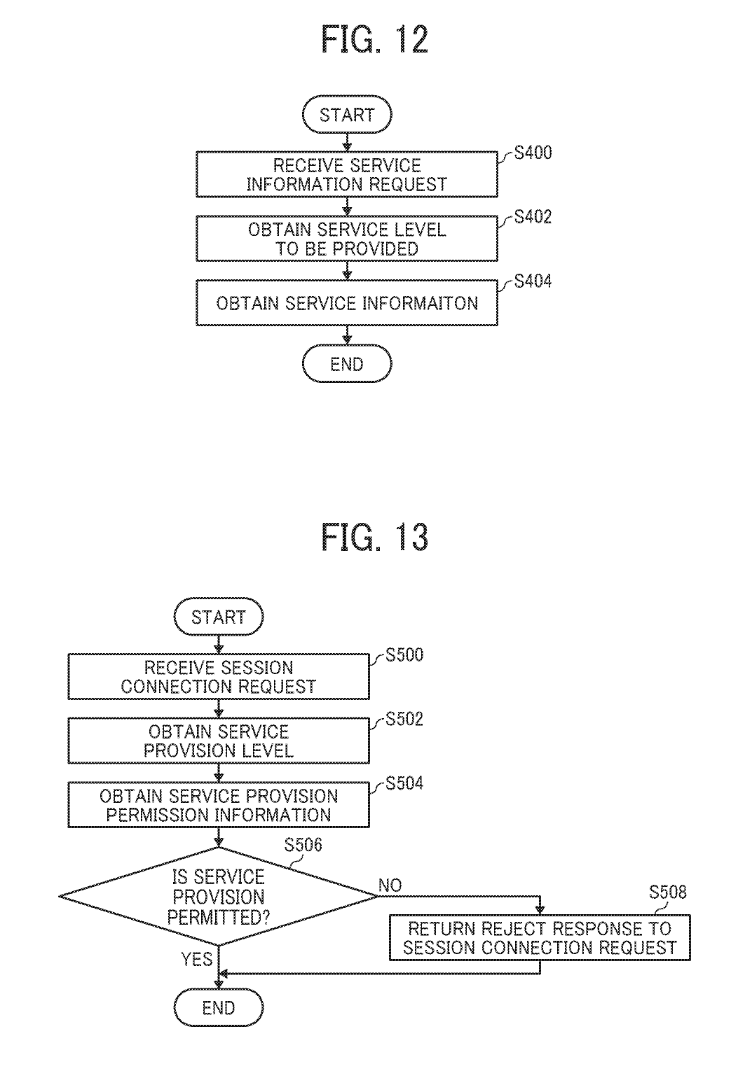

FIG. 12 is a flowchart of processing performed in a case where the ASP 24 generates the service information. When the second communication device 20 receives the service information request from the first communication device 10, the service information generator 242 of the ASP 24 generates the service information and then makes a reply (S400). The ASP 24 obtains the corresponding service provision level from the storage 246, with the ID of the first communication device 10 as a key (S402). Next, the ASP 24 obtains the service information from the storage 246, with the service ID and the service provision level as a key (S404). Then, the ASP 24 makes a reply with the service information that has been obtained, as the service information to be open to the first communication device 10.

FIG. 13 is a flowchart of processing performed in a case where the session connection determining unit 244 determines the session connection. When the session connection determining unit 244 receives the session connection request from the first communication device 10 through the communication unit 22, the second communication device 20 returns a response (S500). The session connection determining unit 244 obtains the corresponding service provision level from the storage 246 with the ID of the first communication device 10 as a key (S502).

Next, the session connection determining unit 244 obtains the service provision permission information from the storage 246 with the service ID and the service provision level as a key (S504). Then, the session connection determining unit 244 continues the processing in a case where the service provision permission information indicates Y (S506: Yes), and returns a reject response to the session connection request, to the first communication device 10 through the communication unit 22 (S508) in a case where the service provision permission information indicates N (S506: No).

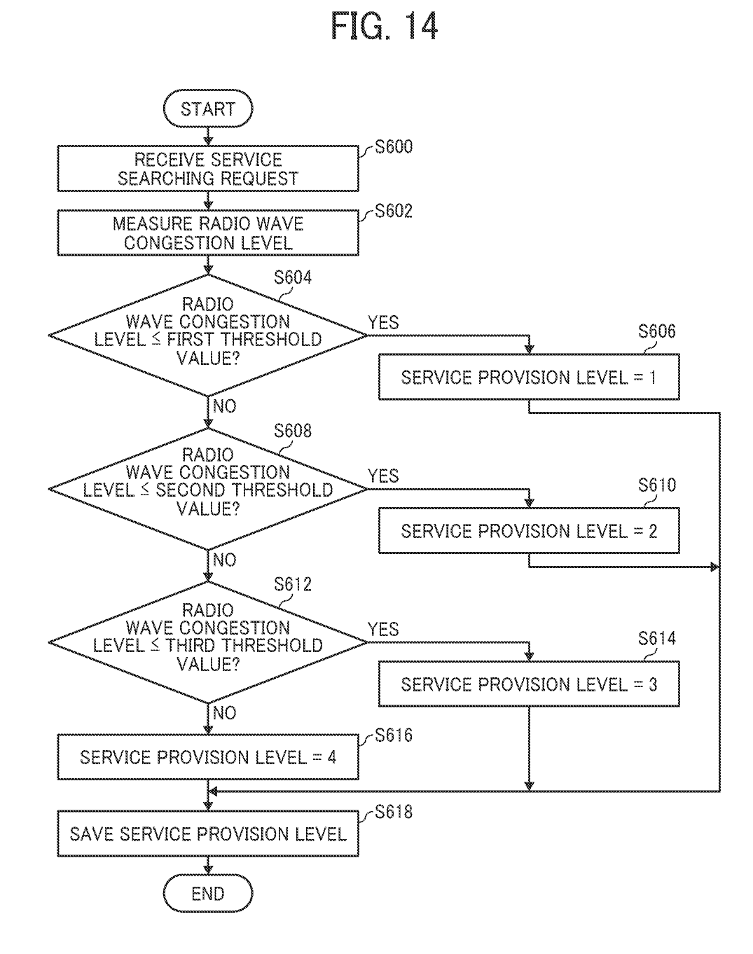

Next, an exemplary different operation of the provision level determining unit 240 will be described. FIG. 14 is a flowchart of processing (an exemplary second operation) performed in a case where the provision level determining unit 240 determines the provision level of the service. As illustrated in FIG. 14, the provision level determining unit 240 receives a service searching request from the first communication device 10 through the communication unit 22 (S600) and then starts determination processing of the provision level of the service.

When receiving the service searching request, for example, the provision level determining unit 240 measures, as the characteristic information, a radio wave congestion level (S602). Here, the provision level determining unit 240 estimates (measures) the radio wave congestion level with a beacon count, for a certain period of time, received from the communication device, such as the first communication device 10.

The provision level determining unit 240 is required to lower the service provision level in a case where the radio wave congestion level is large, and thus selects the service provision level using threshold values. The provision level determining unit 240 compares the radio wave congestion level with a threshold value, that is, three threshold values including first to third threshold values, and, based on comparison, selects the provision level of the service from levels 1 to 4 (S604 to S616). For example, the provision level determining unit 240 sets the service provision level to the level 1 when the radio wave congestion level is equal to or less than the first threshold value, to the level 2 when the radio wave congestion level is equal to or less than the second threshold value, to the level 3 when the radio wave congestion level is equal to or less than the third threshold value, and to the level 4 when the radio wave congestion level is not equal to or less than the third threshold value.

Then, the provision level determining unit 240 saves the service provision level that has been determined, into the storage 246 in association with the ID of the first communication device 10 (S618).

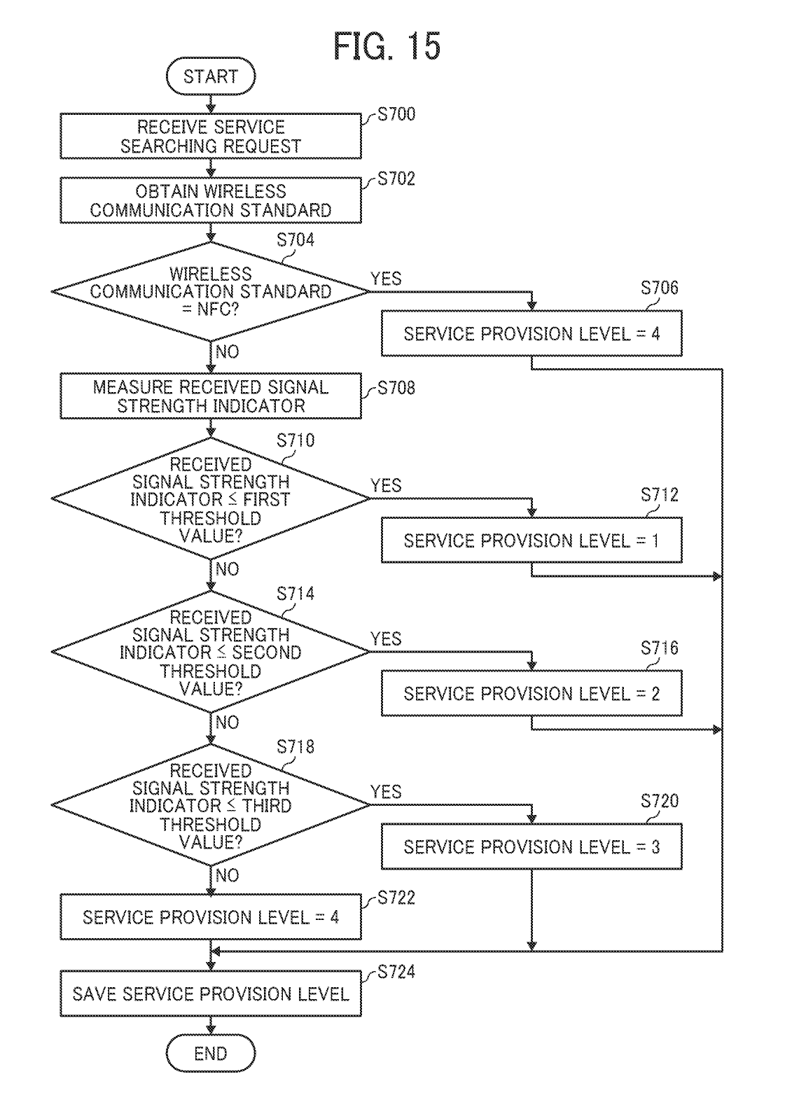

FIG. 15 is a flowchart of processing (an exemplary third operation) performed in a case where the provision level determining unit 240 determines the provision level of the service. As illustrated in FIG. 15, the provision level determining unit 240 receives a service searching request from the first communication device 10 through the communication unit 22 (S700) and then starts determination processing of the provision level of the service.

When receiving the service searching request, the provision level determining unit 240 obtains, as the characteristic information, information indicating the wireless communication standard of communication performed by the second communication device with the first communication device 10 (the type of the wireless communication method) (S702). Here, the provision level determining unit 240 obtains, as the characteristic information, information for distinguishing which one of Wi-Fi, Bluetooth LE (Low Energy), NFC, and NAN the type of the wireless communication method is.

The provision level determining unit 240 determines that the first communication device 10 is sufficiently close to the second communication device 20 in a case where the wireless communication standard indicates NFC (S704: Yes), and then sets the service provision level to 4 (S706). In a case where the wireless communication standard indicates any of the others except NFC (S704: No), for example, the provision level determining unit 240 measures, as the characteristic information, the received signal strength indicator (RSSI) of the service searching request (S708) and then determines the service provision level with the received signal strength indicator.

The provision level determining unit 240 compares the value of the RSSI with a threshold value, that is, three threshold values including first to third threshold values, and based on comparison, selects the provision level of the service from levels 1 to 4 (S710 to S722), in a substantially similar manner as described above referring to S304 to S316 of FIG. 4.

Then, the provision level determining unit 240 saves the service provision level that has been determined, into the storage 246 in association with the ID of the first communication device 10 (S724).

In this manner, the second communication device 20 determines the provision level of the service to be provided to the other communication device, based on the characteristic information on the wireless communication performed with the other communication device. Thus, the service limited with the degree of the service that has been previously determined, can be provided to the other communication device in accordance with the provision level of the service that has been determined. As a result, security can improve.

The second communication device 20 transmits the service information generated by the service information generator 242, to the first communication device 10. Thus, the service information can be limited based on the characteristic information on the wireless communication so that information leakage can be prevented.

In the current WFDS standards, a radio wave in wireless communication reaches up to tens of meters. Thus, even in a case where service utilization is in-house provided desirably, there is a disadvantage that an outside person may use the service. Since service information is provided before connection, the service information leaks outside. Thus, there is a disadvantage that resource information on a company leaks outside.

Meanwhile, the communication device according to the embodiment, limits service utilization through wireless communication from a site away from the communication device so that security can improve.

According to the present embodiment, the computer executes the program to achieve the functions of the provision level determining unit 240, the service information generator 242, the session connection determining unit 244, and the service controller 260. However, part of the units or the entirety of the units may include hardware, such as an application specific integrated circuit (ASIC), a digital signal processor (DSP), or a field programmable gate array (FPGA).

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A communication device comprising:
circuitry to perform wireless communication with other communication device using at least one wireless communication method,
determine a provision level of a service to be provided to the other communication device, based on characteristic information on the wireless communication being performed, and
provide, to the other communication device, a service limited with a degree of the service that has been determined in accordance with the determined provision level.

2. The communication device according to claim 1, wherein the circuitry determines the provision level with, as the characteristic information, a received signal strength indicator of the wireless communication performed being performed.

3. The communication device according to claim 1, wherein the circuitry determines the provision level with, as the characteristic information, a beacon count received at the communication device for a predetermined period of time.

4. The communication device according to claim 1, wherein the circuitry determines the provision level with, as the characteristic information, a type of the wireless communication method with which the communication device has started the wireless communication with the other communication device.

5. The communication device according to claim 1, wherein the circuitry generates service information on the service to be provided to the other communication device, in accordance with the provision level that has been determined, and
transmits the service information that has been generated, to the other communication device.

6. The communication device according to claim 1, wherein the circuitry determines whether to permit a session connection request, based on the provision level that has been determined, when the session connection request for starting the provision of the service has been received, and establishes a session for starting the provision of the service when the session connection request has been permitted.

7. A communication system comprising:
a first communication device; and
a second communication device to provide a service to the first communication device through wireless communication, wherein
the second communication device includes:
circuitry to
perform the wireless communication with the first communication device using at least one wireless communication method;
determine a provision level of the service to be provided to the first communication device, based on characteristic information on the wireless communication being performed, and
provide, to the first communication device, the service limited with a degree of the service that has been determined in accordance with the determined provision level.

8. A communication method comprising:
performing wireless communication with other communication device using at least one wireless communication method;
determining a provision level of a service to be provided to the other communication device, based on characteristic information on the wireless communication being performed; and
providing, to the other communication device, a service limited with a degree of the service that has been determined in accordance with the determined provision level.
